(19) United States
(12) Patent Application Publication
(10) Pub. No.: US 2006/0004637 A1
(43) Pub. Date: Jan. 5, 2006

(54) Method for selling maintenance and process support services for papermaking machines

(76) Inventors: Tatu Pitkanen, Jarvenpaa (FI); Timo Pekkarinen, Tampere (FI); Ilkka Naatti, Vantaa (FI); Kaarlo Lackman, Jarvenpaa (FI)

Correspondence Address: STIENNON & STIENNON, 612 W. MAIN ST., SUITE 201, P.O. BOX 1667, MADISON, WI, 53701-1667, US

(21) Appl. No.: 10/883,463

(22) Filed: Jul. 1, 2004

(51) Int. Cl. G06F 17/60

(52) U.S. Cl. 705/26

(57) ABSTRACT

A papermaking machine unit has a measurement system which provides performance data. The machine supplier sells maintenance and process support services at a price determined by the level of performance of the machine within a given time period. The supplier and the customer agree on a desired performance level, and the charge to the customer is set at a fixed price plus a variable price based on performance level. The amount paid to the supplier will be greater than the fixed price if performance is greater than the desired level, and will be less than the fixed price if performance is less than the desired level.

### BACKGROUND OF THE INVENTION

The present invention relates to methods of selling maintenance and process support services in general and for papermaking machines in particular.

In this application “papermaking machines” refers to any systems and devices relating to papermaking, such as systems and devices for production of pulp, paper, tissue, paperboard and cardboard, as well as finishing and converting systems and automation systems for papermaking.

Maintenance services of a papermaking machine include e.g. pro-active maintenance actions, such as failure and wear root cause measurements and analysis, predictive maintenance actions, such as condition monitoring and condition tests, preventive maintenance actions, such as scheduled maintenance, help desk services, remote troubleshooting using remote diagnostic systems, corrective maintenance actions used when remote operations are not adequate, and supporting maintenance services, such as documentation service and inspection of welded seams and machine frame wearing. The process support services of a papermaking machine include e.g. process tuning and optimization actions, which improve and optimize process efficiency and performance.

With today's papermaking machines the focus with maintenance actions is shifting from conventional methods in which upcoming failure situations are taken care of and broken parts are changed to predictive and proactive efforts. Predictive and proactive maintenance methods include active and real-time follow-up of the condition of the papermaking machine in the form of measuring various condition related parameters and analyzing these parameters to make predictions of the future maintenance needs. This has become possible only with modern diagnostics devices and intelligent measurement and analysis systems integrated with papermaking machines.

There has also raised needs for novel financing options for the customers buying papermaking machines. U.S. patent application Ser. No. 09/946,045 introduces a method for selling upgrade packages in papermaking in which method the customer pays the upgrade package as a sum of a fixed price and a cumulative price depending on the amount of produced paper.

In the above-described system the papermaking machine supplier does not have control of the production performance and thus cannot affect the term during which the customer pays the remaining cumulative price.

Also there is a need in the market to offer customers a wider variety of payment programs. Then the customer is allowed to decide whether he is willing to pay the whole purchase at once, in smaller amounts as defined in a payment program, or not to pay the capital costs at all but make a lease agreement.

### SUMMARY OF THE INVENTION

The business method of this invention is to sell a maintenance and process support service or maintenance agreement in terms of a realized performance level or performance capacity of a papermaking machine or a papermaking machine unit As a consequence the customer pays for the realized production performance and capacity. E.g. for the reeling device the performance capacity can be measured in terms of broke, turnup reliability, tail threading performance, usability meters, operational reliability and of the total production performance. The invention is applicable to a whole papermaking line or to part of it or to a single unit, such as the reeling unit or a calender unit, of the papermaking line.

The service provider offering the maintenance and process support agreements according to the invention may be the supplier of the papermaking machines or machine units or it may be another party offering the service. Since the papermaking machines are rather complicated systems requiring in-depth knowledge of the service personnel, it is typical that the service provider is the papermaking machine supplier or a closely related unit of the papermaking machine supplier.

It is an object of the present invention to provide a method of marketing papermaking machines and papermaking machine services, which allows the machine supplier to more cost-effectively market its products.

It is another object of the present invention to provide a method for the supplier to shift the focus from devices to value and services wherein the customer pays more for the actual production and only at the time when it actually becomes productive.

It is a further object of the present invention to provide a method for maintaining an agreed performance level of papermaking machines.

Further objects, features and advantages of the invention will be apparent from the following detailed description.

### BRIEF DESCRIPTION OF THE DRAWINGS

FIG. 1 illustrates the method and system of collecting performance related information of a papermaking machine.

### DESCRIPTION OF THE PREFERRED EMBODIMENTS

The present invention makes it possible for the paper mills to achieve a guaranteed production performance level of the papermaking machine for most of the production time and minimizing the down-time in a case of a failure when making a maintenance and process support service agreement according to the invention. The price of the maintenance and process support service agreement is expressed in terms of a total fee F_{T} which is a sum of a basic fee F_{B} and a variable fee F_{V}. When making the agreement according to the invention the service provider and the customer agree on the desired performance level being maintained during the normal operation of the papermaking machine or the papermaking machine unit. Also the payment period is agreed upon. The agreed payment period may be one month or one year or any other suitable charging period.

The customer pays the basic fee F_{B} every payment period and the amount of the basic fee stays constant. The variable fee F_{V} depends on the realized performance is level. Its sign is negative if the agreed performance level has not been met and in this case the customer actually pays less for the maintenance service agreement. If the agreed performance level has been met the sign of the variable price P_{V} is positive and the customer pays more. This way the customer achieves an agreed performance level for most of the operation time or pays less for those periods during which the agreed performance level has not been met. Also the customer pays more for those periods during which the performance level has been above the agreed performance level and the production output has been higher than expected. The papermaking machine supplier or the service provider can make more profit with the service agreement when it has succeeded in maintaining the agreed performance level. The absolute value of the variable fee F_{V} depends on how much or for how long the realized performance level has stayed above or below the agreed performance level.

From the service provider's point of view, the achieved and exceeded performance level produces a bonus price, i.e. extra profit for the service provider. When the agreed performance level has not been met the service provider makes less profit as a form of lower maintenance agreement price. This encourages the service provider to make efforts to maintain the agreed performance level.

The terms of defining the parameters determining the performance level may be changed if the running parameters of the papermaking machine or the papermaking machine unit have been changed.

According to an embodiment of the invention, a papermaking machine or a papermaking machine unit and a maintenance and process support service agreement is sold to the customer at a price, which depends on one hand on the composition of the delivered system and on the other hand on the payment terms of the maintenance and process support service agreement. If the price of the capital goods is higher, the maintenance and process support service agreement payments may be agreed on at a lower level than usual. If the capital goods are sold at a lower price than usual, the payment terms of the maintenance and process support service agreement maybe set to a higher level.

The use of the method according to the invention is applicable in papermaking machines which are equipped with a measurement system for collecting performance related information of the papermaking machine and a novel maintenance system, which allows the service provider to make immediate maintenance operations in a failure situation or perform proactive maintenance acts in response to predicted failures. This way it is possible for the service provider to maintain the agreed performance level.

The measurement system for collecting performance related information comprises means for collecting data from the papermaking machine, means for processing data and means for showing data to the users and maintenance personnel of the papermaking machine. Preferably the system also comprises a remote or local information system for processing automated maintenance acts and/or for performing remote automatic corrective acts in the failure situation.

The maintenance service agreement according to the invention includes delivering reports to the customer on the realized performance level, statistical information and any other performance and maintenance related information.

The customer is usually obliged to take care of the daily maintenance and cleaning tasks, such as cleaning paper pieces away, washing, making visual oil leakage inspections, and any other normal machine operation observations as well as changing consumables such as fabrics and doctor blades, seals and nozzles. Spare parts and consumables may be charged separately if the customer has not made a spare part delivery agreement with the supplier.

The typical diagnostic measurements measured for determination of the performance and condition level of the reel unit (used here as an example) of the papermaking machine are:

Stress measurement and analysis of the frames

Bearing condition monitoring

Roll and reel spool monitoring

Linear guide ways monitoring

Monitoring mechanical drives and couplings

Reeling belt condition measurement

Movement time monitoring and friction measurement

Hydraulic oil temperature and hydraulic valve condition measurement

Hydraulic cylinder condition measurement

Hydraulic pressure measurements of position and force controls

Hydraulic pump monitoring

Turn-up equipment pressure monitoring

Turn-up success

Tail threading time

Availability

Break times

Waste

Automatic system diagnostics indications

Sensors, actuators, I/O-cards and other HW diagnostics

Sensor 0-point and calibration monitoring

Electric drives and motor condition

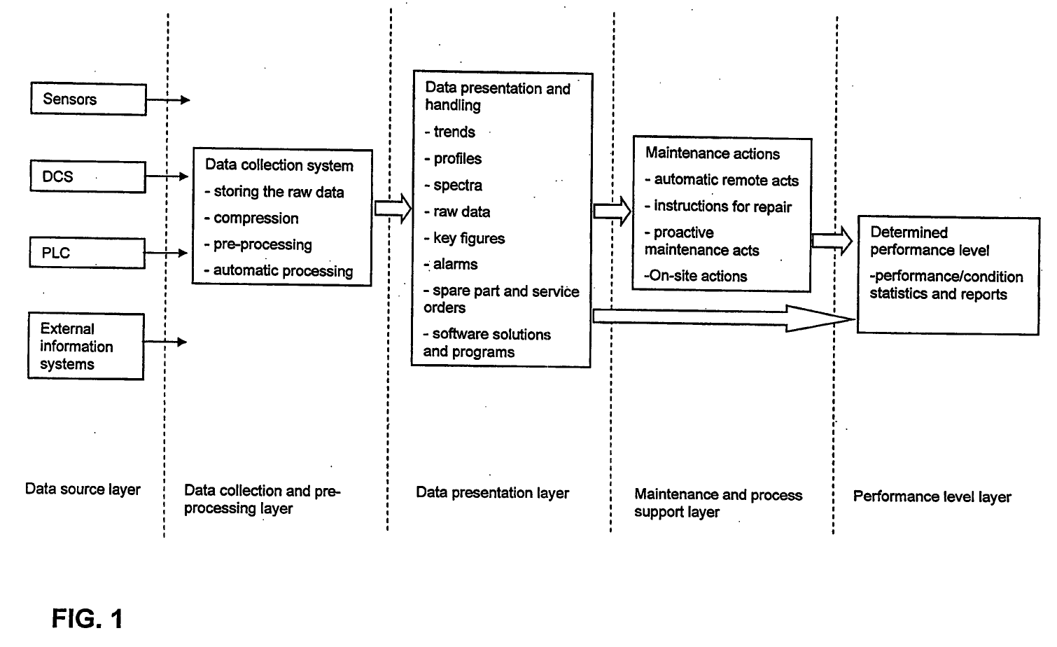

Diagnostic system in the performance level monitoring system comprises equipment for necessary measurements, data collection, analysis, and data communications. FIG. 1 illustrates the data and information flow in the measurement system. The data source layer comprises means for acquiring the measurement data for the performance level determination. The hardware of the measurement devices may comprise sensors, PC's, dataloggers, measurement cards, DCS's (Distributed Control System), PLC's (Programmable Logic Controller), and wiring, as well as external information systems, such as MES (Manufacturing Execution System), process and information systems and ERP (Enterprise Resource Planning). Some signals may be taken from the automation system of the papermaking machine through straight sensor I/O's with hard wiring, through fieldbus interfaces, through local area network based interfaces or through software based interface.

The data collection and preprocessing layer comprises means for processing the collected data. This layer performs e.g. storing the raw data, the data compression, pre-processing, and automatic procedures, such as automatic alarms. These processes turn the collected data into useful information, which is transmitted to the next layer, i.e. the data presentation layer. The data presentation layer takes care of presenting the collected and pre-processed data in a useful and illustrative form. The data presentation layer comprises means for presenting trends, profiles, spectra, raw data, key figures and alarms to the operators, maintenance personnel and other parties using the system. The data presentation layer may also comprise means for generating spare part and service orders as well as applicable software solutions and programs.

The applicable data is taken to the maintenance and process support layer, which represents any necessary maintenance and process support operations, such as automatic remote acts, instructions for repair to be delivered to the maintenance personnel as well as proactive maintenance acts and on-site actions. Information about the maintenance and process support actions are taken to the performance level layer as well as the information from the data presentation layer. Now the current performance level can be determined using data from the previous layers. The charging department or other party responsible for the actual charging uses the performance level information to generate bills for the customer.

According to the invention the customer pays a fixed price per time unit or payment period, which is typically one month or one year. The maintenance and process support service agreements may be made for one year at a time or for a longer time. Typically they are long-term agreements since this way the most benefit is made with the agreement. The agreement comprises the agreed performance level determined with the performance measures according to the invention.

Using the method according to the invention, the supplier can reach higher life cycle profitability through better-targeted maintenance and spare part services, process expertise and reliability optimizations.

It should be noted that an invoice may be generated following the agreed upon period of time which would invoice the customer for a total fee which is the sum of the basic fee and the variable fee, the variable fee being adjusted based on a function of the realized performance level and the agreed performance level. Moreover, a price list for the purchase price and the maintenance contract of the papermaking machine may be developed for the papermaking machine, such that the purchase price is lower when the basic fee and the variable fee are higher.

In the following the patent claims will be given and various details of the invention may show variation within the scope of the inventive idea defined in the patent claims and differ from the details disclosed above for the sake of example only.

We claim:

1. A method for selling maintenance and process support services in terms of a performance level of a papermaking machine or a papermaking machine unit, which papermaking machine or a papermaking machine unit is equipped with a measurement system providing performance level related information, the method comprising the steps of:
agreeing to a desired performance level of the papermaking machine or the papermaking machine unit with the customer;
agreeing with the customer on a basic fee F_{B} for the maintenance and process support service agreement per an agreed period for providing the agreed performance level and a variable fee F_{V}, which depends on the realized performance level;
selling a service agreement containing terms for an agreed performance level of the papermaking machine or the papermaking machine unit and for the basic fee and the variable fee, wherein the total fee F_{T} paid by the customer to the service provider is a sum of the basic fee and the variable fee such that F_{T}=F_{B}+F_{V}.

2. The method of claim 1 wherein the variable fee has a positive sign for those periods during which the agreed performance level has been met and the absolute value of the variable fee depends on how much the realized performance level has been above the agreed performance level.

3. The method of claim 1 wherein the variable fee has a negative sign for those periods during which the agreed performance level has not been met and the absolute value of the variable fee depends on how much the realized performance level has been below the agreed performance level.

4. The method of claim 1 wherein the total fee per agreed period is dependent on the realized sales price and/or production output, such as tons or meters, of the papermaking machine or a papermaking machine unit.

5. The method of claim 1 wherein the performance level is determined using a measurement system providing performance level related information and comprising means for determining performance measures in a group consisting of machine speed, production down time, amount of broke, turnup reliability, tail threading performance, usability meters, operational reliability, amount of produced goods and any other measures determining performance level of the papermaking machine or the papermaking machine unit.

6. A method for selling a papermaking machine or a papermaking machine unit and a maintenance and process support service agreement, which papermaking machine or papermaking machine unit is equipped with a measurement system providing performance level related information, the method comprising the steps of:
agreeing to a desired performance level of the papermaking machine or the papermaking machine unit with a customer, agreeing with the customer on a sales price for the papermaking machine or papermaking machine unit;
agreeing with the customer on a basic fee F_{B} for the maintenance and process support service agreement per an agreed period for providing the agreed performance level and a variable fee F_{V}, which depends on the realized performance level; and
selling a papermaking machine or a papermaking machine unit and a service agreement containing terms for an agreed performance level of the papermaking machine or the papermaking machine unit and for the basic fee and the variable fee, wherein the sales price of the papermaking machine or papermaking machine unit depends on the fee of the maintenance and process support service agreement per an agreed period.

7. A method for selling maintenance and process support services in terms of a performance level of a reel unit of a papermaking machine, which reel unit is equipped with measurement system providing performance level related information, the method comprising the steps of.
agreeing to a desired performance level of the reel unit with the customer;
agreeing with the customer on a basic fee F_{B} for the maintenance and process support service agreement per an agreed period for providing the agreed performance level and a variable fee F_{V}, which depends on the realized performance level;
selling a service agreement for the reel unit, the service agreement containing terms for an agreed performance level of the reel unit and for the basic fee and the variable fee, wherein the total fee F_{T} paid by the customer to the service provider is a sum of the basic fee and the variable fee such that F_{T}=F_{B}+F_{V}.

8. The method of claim 7, wherein the performance level is determined in terms of broke, turnup reliability, tail threading performance, usability meters, operational reliability and of the total production performance of the reel unit.

9. A method for selling a papermaking machine or a papermaking machine unit comprising the steps of:
agreeing to a selected performance level of the papermaking machine or the papermaking machine unit with a customer,
agreeing with the customer to a basic fee for maintenance and process support service for a selected period of time;
agreeing with the customer to a variable fee, which is dependent on a realized performance level;
determining an actual performance level for the selected period of time by processing data from measuring systems which equip the papermaking machine or papermaking machine unit; and
generating an invoice following the selected period of time for a total fee which is the sum of the basic fee and the variable fee, said variable fee being adjusted based on a function of the realized performance level and the agreed performance level.

10. The method of claim 9 wherein the variable fee has a positive sign for those periods during which the agreed performance level has been met and the absolute value of the variable fee depends on how much the realized performance level has been above the agreed performance level.

11. The method of claim 9 wherein the variable fee has a negative sign for those periods during which the agreed performance level has not been met and the absolute value of the variable fee depends on how much the realized performance level has been below the agreed performance level.

12. The method of claim 9 wherein the total fee per agreed period of time is dependent on a realized sales price, or production output of the papermaking machine or papermaking machine unit.

13. The method of claim 9 wherein the performance level is determined using a measurement system providing performance level related information and comprising means for determining performance measures selected from a group consisting of machine speed, production down time, amount of broke, turnup reliability, tail threading performance, usability meters, operational reliability, amount of produced goods and any other measures determining performance level of the papermaking machine or the papermaking machine unit.

14. A method for selling a papermaking machine or a papermaking machine unit comprising the steps of:
agreeing to a selected performance level of the papermaking machine or the papermaking machine unit with a customer,
agreeing with the customer on a selected sales price for the papermaking machine or papermaking machine unit;
agreeing with the customer to a basic fee for maintenance and process support service for a selected period of time, for providing the selected performance level;
agreeing with the customer to a variable fee, which is dependent on an actual performance level;
determining the actual performance level for the selected period by processing data from measuring systems which equip the papermaking machine or papermaking machine unit;
agreeing with the customer to a selected sales price for the papermaking machine or papermaking machine unit; and
developing a price list for the papermaking machine or the papermaking machine unit and for the basic fee and the variable fee, wherein the price list for the papermaking machine or the papermaking machine unit varies inversely with the fee of the basic fee and the variable fee per selected period.

15. A method for selling a reel unit comprising the steps of:
agreeing to a selected performance level of the reel unit with a customer,
agreeing with the customer to a basic fee for maintenance and process support service for a selected period of time;
agreeing with the customer to a variable fee, which is dependent on a realized performance level;
determining an actual performance level for the selected period of time by processing data from measuring systems which equip the papermaking machine or papermaking machine unit; and
generating an invoice following the selected period of time for a total fee which is the sum of the basic fee and the variable fee, said variable fee being adjusted based on a function of the realized performance level and the agreed performance level.

16. The method of claim 15, wherein the performance level is determined in terms of broke, turnup reliability, tail threading performance, usability meters, operational reliability and total production performance of the reel unit.

17. A method for charging a customer for maintenance and process support services for a papermaking machine, wherein a desired performance level of the papermaking machine has been set by the customer; the method comprising the steps of:
monitoring a papermaking machine with a measurement system which provides performance level related information;
based on the performance level related information, determining the level of performance over the course of a time period;
determining an invoice amount for the time period which comprises a predetermined fixed amount and a variable amount based on the determined performance level, said variable amount being negative if the determined performance level is less than the desired performance level, and the variable amount being positive if greater than the the desired performance level; and
invoicing the customer for the determined invoice amount
